(19) United States
(12) Patent Application Publication
(10) Pub. No.: US 2015/0364777 A1
(43) Pub. Date: Dec. 17, 2015

(54) Fuel Cell System

(71) Applicant: Bayerische Motoren Werke Aktiengesellschaft, Muenchen (DE)

(72) Inventors: Stefan HAASE, Muenchen (DE); Johannes SCHMID, Muenchen (DE)

(21) Appl. No.: 14/836,578

(22) Filed: Aug. 26, 2015

Related U.S. Application Data
(63) Continuation of application No. PCT/EP2014/050927, filed on Jan. 17, 2014.

(30) Foreign Application Priority Data
Feb. 27, 2013 (DE) 10 2013 203 311.7

(51) Int. Cl. H01M 8/04; H01M 8/10; H01M 8/02

(52) U.S. Cl. CPC H01M 8/04074; H01M 8/0247; H01M 8/1004

(57) ABSTRACT

A fuel cell system has a plurality of individual fuel cells which are combined into a stack, where each of the individual fuel cells has a substantially planar membrane-electrode unit, two gas diffusion layers in the form of a fiber structure and of a bipolar plate, which establishes the electrical connection to the adjacent individual fuel cell that is located above or below. The gas diffusion layers adjoin the larger surfaces of the membrane electrode unit, which are located opposite of one another, and the bipolar plate comprises an active region surrounded by an edge region. In addition, the bipolar plates in the active region have a completely flat design so that the gas-carrying region is formed exclusively by the gas diffusion layers, what amounts to at least 60% of the height of an individual fuel cell.

### CROSS REFERENCE TO RELATED APPLICATIONS

This application is a continuation of PCT International Application No. PCT/EP2014/050927, filed Jan. 17, 2014, which claims priority under 35 U.S.C. §119 from German Patent Application No. 10 2013 203 311.7, filed Feb. 27, 2013, the entire disclosures of which are herein expressly incorporated by reference.

### BACKGROUND AND SUMMARY OF THE INVENTION

The present invention relates to a fuel cell system with multiple single fuel cells which are combined to form a stack and respectively consist of a substantially planar membrane-electrode assembly, two gas diffusion layers, in the form of a fibrous structure, adjoining the larger surfaces opposite from one another of the membrane-electrode assembly, and a bipolar plate, establishing the electrical connection with the adjacent single fuel cell lying thereover or thereunder and having an active region surrounded by a peripheral region.

By using catalysts consisting of platinum or platinum-containing alloys, fuel cell systems achieve high power densities, active areas of 200 to 350 cm² being used. These fuel cell systems generally have cooling plates, in which a cooling medium is carried. In order to generate a flux field for the cooling medium, usually profiled bipolar plates are required. Cost-intensive perfluorinated membranes are used as membranes. In addition, an end-plate assembly is required for each fuel cell stack.

The high power densities require a complex cooling and wetting concept for the membranes, reduce the efficiency and tend to make the components corrode. A cooling concept with liquid cooling requires cooling channels, which increase the overall height of the individual cells. The electrical resistance of the contact of the bipolar plates necessary for the forming of the cooling channels reduces the power capacity and/or requires minimizing coating processes. Constructions with complex flux fields have an increased space requirement and cause additional costs on account of multiple production steps in their manufacture. Furthermore, on account of the low availability of the precious metal platinum, and the high requirement per fuel cell, it is not possible to gain sufficient market penetration with fuel cell vehicles. The perfluorinated membranes used are also complex to manufacture and cost-intensive.

On the basis of this prior art, it is therefore the object of the present invention to provide a fuel cell system of the type mentioned at the beginning that is particularly thin, does not have disadvantages in terms of weight, volume and efficiency and, in addition, can be achieved at low cost.

In the case of a fuel cell system with multiple single fuel cells which are combined to form a stack and respectively consist of a substantially planar membrane-electrode assembly, two gas diffusion layers, in the form of a fibrous structure, adjoining the larger surfaces opposite from one another of the membrane-electrode assembly, and a bipolar plate, establishing the electrical connection with the adjacent single fuel cell lying thereover or thereunder and having an active region surrounded by a peripheral region, this object is achieved according to the invention by the bipolar plates being made completely planar in the active region, so that the gas-carrying region is formed exclusively by the gas diffusion layers, which makes up at least 60% of the height of a single fuel cell.

The subclaims contain advantageous developments and refinements of the invention.

It is advantageously provided that the thickness of the membrane-electrode assembly is of the order of magnitude of 10-50 μm and/or the thickness of the gas diffusion layer is of the order of magnitude of 50-150 μm and/or the thickness of the bipolar plate is of the order of magnitude of 10-100 μm.

If a cooling-channel structure, containing at least one cooling channel for carrying a coolant, is also provided in the fuel cell system, then according to a preferred development the cooling-channel structure is provided adjoining at least one of the lateral edges of the single fuel cells.

According to an advantageous refinement, at least two such stacks of single fuel cells are provided, arranged next to one another and having a common cooling-channel structure between them. As a result of this refinement, the individual stacks can be put together in any way desired on the basis of the modular principle. Furthermore, an altogether quite compact structural form of the fuel cell system according to the invention is obtained.

If end plates are provided at the free ends of the respective stack, advantageously at least two stacks of single fuel cells arranged next to one another have a common end plate. This produces the same conditions for tapping current and for handling as in the case of a conventional fuel cell system.

The cooling channels provided in different cooling-channel structures may advantageously be connected in cross-flow, parallel, series or parallel with an alternating direction of flow. This also makes faster starting in cold or frosty conditions possible. In the case of multiple stacks, the coolant mass flow may then either be divided or flow through all of the stacks one after the other. Also, in keeping with a fixed stack geometry, the directions of flow of the individual stacks may vary (for example 1st stack from top to bottom; 2nd stack from left to right).

Furthermore, additional cooling plates containing at least one cooling channel may be provided at preferably periodic intervals within a stack of single fuel cells. This improves the cooling and the temperature distribution within the stack. For example, such an internal cooling channel may be provided after every 10 to 30 bipolar plates.

According to a preferred refinement, the bipolar plates are coated with a catalyst material that is substantially free from platinum or platinum-containing alloys.

As a result of the slender structural form brought about by the external cooling channels and as a result of the low power density, so little gas per inlet area is required that consequently no channels are necessary within the bipolar plates. A flow through the gas diffusion layer is sufficient here. Because of its planar design, the bipolar plate can be of a very thin form (<100 μm ; aim: the thickness of aluminum foil). This results in a lowering of the mass, the processing time, the thermal mass for cold starting, the thickness (aim: 150 μm to 300 μm) of the individual fuel cells, and consequently also the overall volume and the manufacturing costs. The coating is also much easier.

By eliminating the cooling channels inside the stack, there is a reduction in the height of the individual stacks. This can at least partially compensate for the disadvantage of the higher necessary active areas, so that at most an only slightly increased overall volume has to be expected in the case of the fuel cell system according to the invention in comparison with conventional fuel cells. In addition, on account of the elimination of the internal cooling channels, it is also possible for only one bipolar plate per fuel cell to be used.

The low requirements for proton conductivity with respect to the power density also allow lower-cost membrane materials (hydrocarbon membranes, composite membranes, etc.) to be used. In addition, high-temperature membranes may be used, or the fuel cell system may be operated at higher temperatures. This is so because, as a result of the facilitated cooling capability, a greater temperature difference with respect to the surroundings can be tolerated, which is accompanied by higher power—for example in the case of use in a motor vehicle.

In addition, it is also possible here to dispense with (or greatly reduce) the humidification of the gases, since with the low power densities the conductivity can also be achieved with low relative humidity levels.

Since no platinum or only small amounts of platinum is/are used, a considerable lowering of the material costs is obtained. Although, owing to the currently still low activity of the platinum-free catalysts, at voltages of 0.6 to 0.75 V only low power densities (for example 200 mA/cm²) can be achieved, so that a multiple of active area in comparison with conventional fuel cell systems with a power density of >1 W/cm² is needed to yield similar overall power outputs, a very slender structural form in the plane of the bipolar plates (about 30-80 mm) can be achieved on account of the fact that the cooling of the individual stacks takes place by way of the heat conduction of the bipolar plates to external cooling channels.

Further details, features and advantages of the invention emerge from the following description on the basis of the drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a plan view of a fuel cell system according to the invention,

FIG. 2 shows a section through the fuel cell system according to FIG. 1,

FIG. 3 shows a detail of a cross section through a stack of single fuel cells, and

FIG. 4 shows a cross section through a fuel cell system.

### DETAILED DESCRIPTION OF THE DRAWINGS

In the figures, only the parts of the fuel cell system that are of interest here are represented; all other elements have been omitted for the sake of overall clarity.

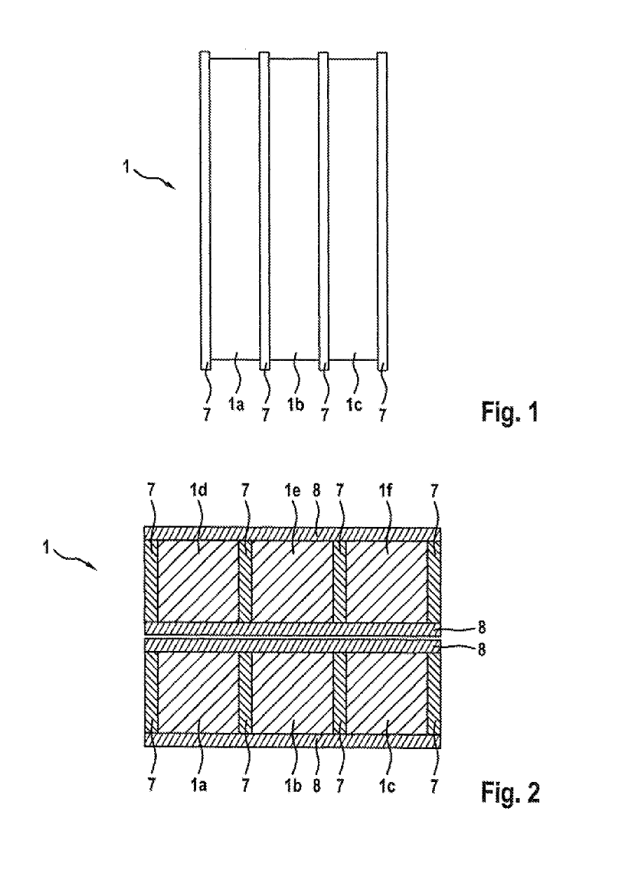

FIGS. 1 to 3 show a fuel cell system 1 according to the invention with multiple, substantially rectangular or square single fuel cells 2 respectively combined to form a stack 1a-1f. The single fuel cells 2 respectively consist of a substantially planar membrane-electrode assembly 3, two gas diffusion layers 4, 5, in the form of a fibrous structure, adjoining the larger surfaces opposite from one another of the membrane-electrode assembly 3, and a bipolar plate 6, establishing the electrical connection with the adjacent single fuel cell 2 lying thereover or thereunder and having an active region surrounded by a peripheral region.

The bipolar plates 6 are made completely planar in the active region, so that the gas-carrying region is formed exclusively by the gas diffusion layers 4, 5, which makes up at least 60% of the height of a single fuel cell 2. The bipolar plates 6 are also coated with a catalyst material that is free from platinum or platinum-containing alloys.

In the fuel cell system 1, multiple stacks 1a-1f of single fuel cells 2 are arranged next to one another and one behind the other. Each stack 1a-1f is provided with an external cooling-channel structure 7, arranged on two sides that are opposite from one another. In this case, mutually adjoining stacks 1a/1b and 1b/1c and 1d/1e and 1e/1f of single fuel cells 2 share a cooling-channel structure 7 (see FIG. 2). The cooling channels in different cooling-channel structures 7 may be connected in cross-flow, parallel, series or parallel with an alternating direction of flow. In the case of multiple stacks 1a-1f, the coolant mass flow may then either be divided or flow through all of the stacks 1a-1f one after the other. Also, in keeping with a fixed stack geometry, the directions of flow of the individual stacks 1a-1f may vary (for example 1st stack from top to bottom; 2nd stack from left to right).

Furthermore, in addition to the external cooling-channel structure 7, additional cooling plates containing at least one cooling channel may be arranged at periodic intervals within each stack 1a-1f, for example after every 10 to 30 single fuel cells 2, in order to improve the cooling and the temperature distribution within a cell stack 1a-1f.

On the sides that are free from the cooling-channel structure 7, the stacks 1a-1c and 1d-1f arranged next to one another are connected to a common end plate 8.

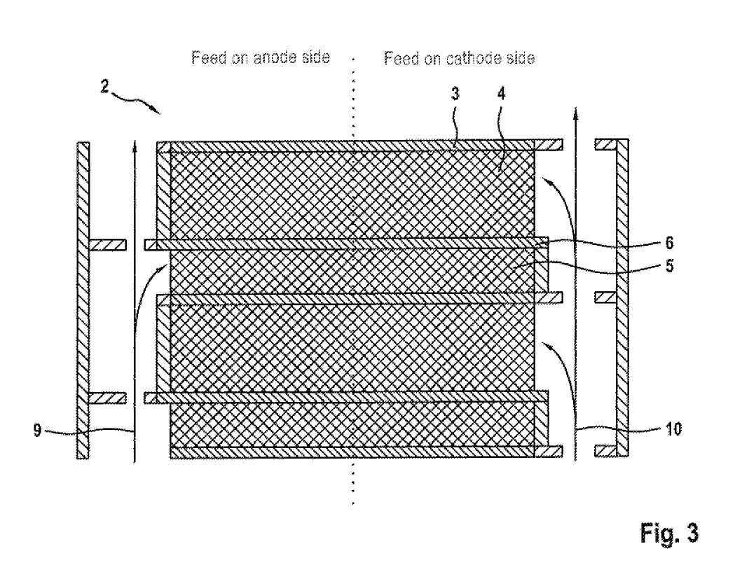

FIG. 3 shows a detail of a cross section of a stack 1a-1f. Shown on the left-hand side is a detail in which the feed of the hydrogen 9 to the cell plane is located. The hydrogen 9 is conducted laterally in relation to all of the single fuel cells 2 and enters the single fuel cells 2 through regions with openings in the sealing region. In this way, the hydrogen mass flow is exclusively conducted through the anode-side gas diffusion layer 5 and fed to the reaction zones. Through further open sealing regions (not represented here), the remaining gas is fed to a lateral discharge (similar to the feed). The feed of the oxygen 10 to the single fuel cells 2 is represented on the right-hand side of FIG. 3. The principle is identical to the feeding of the hydrogen. It is important here that the flow through the regions of the reaction areas takes place exclusively through the gas diffusion layers 4, 5 and that the bipolar plates 6 are of a planar form, without a stamped structure.

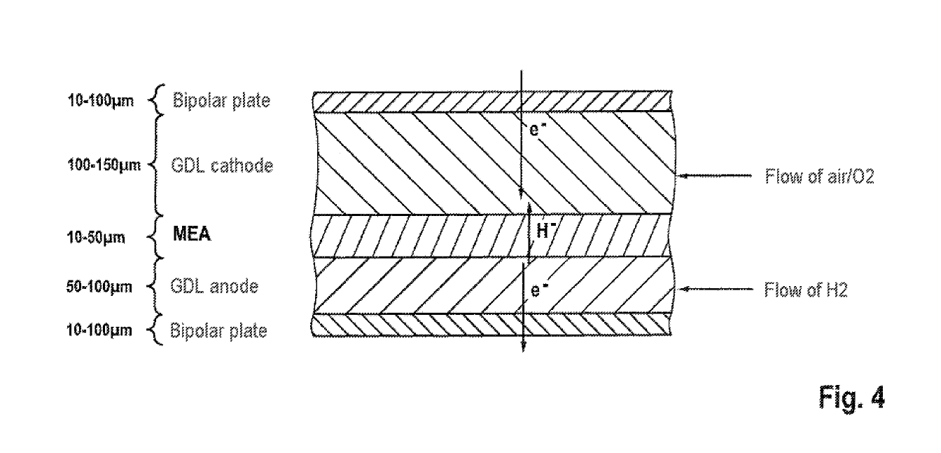

In FIG. 4, a schematic structure of a fuel cell system 1 according to the invention is shown. The dimensions of the individual parts are also indicated here, in order to show that the fuel cell system 1 according to the invention has only a small thickness.

The thickness of the membrane-electrode assembly (MEA) 3 is of the order of magnitude of 10-50 μm, that of the gas diffusion layer (GDL) 4, 5 is of the order of magnitude of 50-150 μm and/or that of the bipolar plate 6 is of the order of magnitude of 10-100 μm. On account of this design, in the most favorable case a minimum thickness of 180 μm is consequently obtained, while previously thicknesses of 1000-1500 μm were usual.

The solution according to the invention leads to higher activities of the catalyst on account of the fact that higher operating temperatures can be achieved. This can make lower loading possible, or the use of a more affordable catalyst material. Furthermore, a thin material can be used for the bipolar plates 6, since the bipolar plates 6 have to have scarcely any stiffness because of the absence of supports or stampings. The gas diffusion layers 4, 5 likewise do not need any stiffness, since they lie flat, which in turn leads to a higher conductivity.

Furthermore, on account of the geometrical design, the main mass flow for the distribution of the gases can pass through the gas diffusion layers 4, 5, and the heat transfer can take place by way of the transverse conductivity of the bipolar plates 6, the gas diffusion layers 4, 5 and the membrane-electrode assembly 3. In addition, because of the ideally high temperatures of 100-150° C., there are scarcely any requirements for the conductivity of the membrane, which is dependent on the relative atmospheric humidity.

The foregoing description of the present invention serves only for illustrative purposes and not for the purpose of restricting the invention. Various changes and modifications are possible within the context of the invention without departing from the scope of the invention and the equivalents thereof.

### LIST OF DESIGNATIONS

1 Fuel cell system
1a-1f Stack
2 Single fuel cell
3 Membrane-electrode assembly
4 Gas diffusion layer
5 Gas diffusion layer
6 Bipolar plate
7 Cooling-channel structure
8 End plate
9 Hydrogen
10 Oxygen

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system with a plurality of single fuel cells which are combined to form a stack, wherein each of the plurality of single fuel cells comprises:
a substantially planar membrane-electrode assembly;
two gas diffusion layers in the form of a fibrous structure, wherein the gas diffusion layers are configured to adjoin larger surfaces opposite from one another of the membrane-electrode assembly; and
a bipolar plate configured to establish an electrical connection with an adjacent one of the plurality of single fuel cells lying thereover or thereunder and having an active region surrounded by a peripheral region,
wherein the bipolar plate is made completely planar in the active region such that a gas-carrying region is formed exclusively by the two gas diffusion layers, which makes up at least 60% of the height of a single fuel cell.

2. The fuel cell system as claimed in claim 1, wherein a thickness of the membrane-electrode assembly is between 10 and 50 μm.

3. The fuel cell system as claimed in claim 1, wherein a thickness of one of the two gas diffusion layers is between 50 and 150 μm.

4. The fuel cell system as claimed in claim 1, wherein a thickness of the bipolar plate is between 10 and 100 μm.

5. The fuel cell system as claimed in claim 1, further comprising a cooling-channel structure containing at least one cooling channel configured to carry a coolant, wherein the cooling-channel structure adjoins at least one lateral edge of the plurality of single fuel cells.

6. The fuel cell system as claimed in claim 5, further comprising at least one additional stack of single fuel cells, wherein said stack and one of the at least one additional stack are arranged next said stack have a common cooling-channel structure therebetween.

7. The fuel cell system as claimed in claim 1, further comprising an end plate provided at a free end of the stack, wherein at least two stacks of single fuel cells arranged next to one another have a common end plate.

8. The fuel cell system as claimed in claim 5, further comprising an end plate provided at a free end of the stack, wherein at least two stacks of single fuel cells arranged next to one another have a common end plate.

9. The fuel cell system as claimed in claim 6, wherein said stack and one of the at least one additional stacks arranged next to said stack have a common end plate.

10. The fuel cell system as claimed in claim 1, further comprising a plurality of cooling channels provided in different cooling-channel structures, wherein said plurality of cooling channels are connected in one of cross-flow, parallel, series or parallel with an alternating direction of flow.

11. The fuel cell system as claimed in claim 7, further comprising a plurality of cooling channels provided in different cooling-channel structures, wherein said plurality of cooling channels are connected in one of cross-flow, parallel, series or parallel with an alternating direction of flow.

12. The fuel cell system as claimed in claim 1, further comprising additional cooling plates containing at least one cooling channel provided at periodic intervals within a stack of single fuel cells.

13. The fuel cell system as claimed in claim 1, wherein the bipolar plates is coated with a catalyst material that is substantially free from platinum or platinum-containing alloys.
